(19) United States
(12) Patent Application Publication
(10) Pub. No.: US 2006/0021266 A1
(43) Pub. Date: Feb. 2, 2006

(54) Off-the-ground cemetery memorials

(76) Inventor: Lawrence L. Helwig, Brookings, SD (US)

Correspondence Address: Lawrence L. Helwig, 319 Dogwood Ave., Brookings, SD, 57006, US

(21) Appl. No.: 10/899,579

(22) Filed: Jul. 27, 2004

(51) Int. Cl. G09F 19/00

(52) U.S. Cl. 40/124.5

(57) ABSTRACT

An invention for cemeteries that unifies, by its enveloping features, cemetery memorials and the burial monument while doing away with clutter created by ground level memorials. It has a specially designed bolt that acts as a receiving base for attaching similar designed memorials. The attachment to the surface of the granite monument is achieved thru the use of extra strength adhesives providing long term bonding. The memorials can be joined using different fasteners, but male and female threads have received favorable attention. The bolt with its male threads is fastened to the female threads located in an aperture of the memorial. The aperture is surrounded by a concavity that envelopes the large cross-sectional area of the bolt head giving the memorial and monument a unified appearance. The invention although designed for cemetery memorial situations can be utilized in other similar situations. The simplicity of design not only makes it easy to place into or remove from service, but the low cost will attract the attention of the public and make it competitive with cluttering memorials in use today. Cemetery maintenance costs will be reduced while enhancing the relationship between the public and cemetery administrators.

### BACKGROUND OF THE INVENTION

The inventor with 35 years of experience in cemetery work is aware of the problems associated with cemetery memorials. The technological advancement in today's adhesives and plastic products makes the invention a unique one. It is unique because of its simplicity and how well that feature satisfies the need for solving one of today's major cemetery problems, the nuisance caused by cemetery ground level memorials. The memorials should be placed at levels where they do not interfere with cemetery maintenance. The invention is comprised of two units: (1) a bolt head with a large cross-sectional area with an adhesive attached at one end and male threads at the opposite end, and (2) a memorial having an incorporated bottom or side aperture lined with female threads surrounded by a concavity. Both units are united when placed into service through the engagement of both sets of threads. The simplicity and resulting low cost will be incentives to replace ground littering memorials. There are products on the market, but as witnessed by their absence, they are not being placed into service. The invention's composition will favor, but will not be limited to, molded plastics to keep it competitive with ground level memorials. Potted plants, flower-filled vases, religious symbols, encased photos or other personalized items will make up some of the memorials. Policies set forth by cemetery administrators regulating the duration in which memorials can be shown can be changed as a result of the invention being placed into service. Public sentiment in the past has been affected by these restrictions. Eliminating the chore of handling the memorials during maintenance by grounds maintenance personnel will also lower costs of cemetery up-keep.

### SUMMARY OF THE INVENTION

The invention in its preferred embodiment is designed for attaching graveside memorials to the walls and base of graveside markers to eliminate the clutter caused by ground level memorials. The invention is composed of a combination of materials utilized in many of today's products; the plastics and adhesives. The novelty of the invention is incorporated in its simplicity. It is a bolt composed of threads on one end and a specially designed head on the opposite end, plus a memorial that acts as a nut for the bolt with its threads located in an aperture surrounded by a concavity. The adhesive attached to the bolt head provides an opportunity to elevate the invention off the ground and onto the graveside monument and its base. The design will make the product easy to place into and remove from service and eliminate the cluttering caused by memorials in use today.
A primary purpose of the invention in its preferred embodiment is to provide a product that can be substituted for present day memorials.
Another objective will be realized when the use of the product eliminates handling of memorials during grooming of the cemetery grounds thereby reducing risk of memorial damage and lowering maintenance costs.
A further objective will be met when memorial-removal-deadlines are of no consequence; thereby enhancing the relationship between the public, cemetery administrators and ground maintenance crews.
Other objectives will be realized after studying the accompanying descriptions and drawings of the invention.

### DESCRIPTION OF THE PRIOR ART

Prior art or products that have experienced limited use are either complicated, high cost, or do not apply to cemetery memorials. These limitations will not solve the problems associated with today's graveside memorials. Thirty-five years of experience in cemetery work has shown that the use of problem-solving-cemetery memorials will not take place if they are not aesthetically appropriate, do not employ easy-on-easy-off features or are not cost-competitive with products in use.

Prior art examples: U.S. Pat. No. 6,088,955 granted to J. E. Nelson and P. A. Nelson, U.S. Pat. No. 4,522,366 granted to George H. Howell III lower their graveside memorials into an excavation when not in use and raise them when use is intended.

U.S. Pat. No. 2,734,312 granted to Joseph Vaghi anchors the memorial in concrete using an anchored male threaded stud, which attaches to a female threaded metal aperture in the memorial.

U.S. Pat. No. 5,435,099 granted to Eugene Conway features a clamping device that clamps only on the vertical wall of the monument.

U.S. Pat. No. 6,067,748 granted to Gary W. Williams features vases on swivels and shelves attached to the monument walls.

U.S. Pat. No. 4,842,912 granted to Charles G. Hutter III features a very complicated method for attaching articles to a substrate.

U.S. Pat. No. 5,816,548 granted to John T. Blossom III, U.S. Pat. No. 5,368,268 granted to Gerhard D. Jodwischat, U.S. Pat. No. 6,502,794 B1 granted to Tzu-Kuang Ting, U.S. Pat. No. 3,827,020 granted to Takeshi Okamoto are patents using methods of attachment that do not fit into the burial grounds environment.

U.S. Pat. No. 3,130,103 granted to P. T. Mattimoe et. al. and U.S. Pat. No. 4,593,878 granted to Robert Stewart are patents dealing with the attachment of rear view mirrors to automobile windshields. Both employ readily available adhesives, but differ in their missions. The latter on the safety aspect of mounted mirrors when an automobile crashes; while the former emphasizes the procedure for mounting a mirror utilizing a special apparatus.

U.S. Pat. No. 2,557,434 granted to W. P. Hoverder features a supporting structure that adhesively attaches to a surface to stabilizes the attached article. It differs in design and form of employed adhesive. The concept will result in poor performance.

### A BRIEF DESCRIPTION OF THE DRAWINGS

FIG. 1 Shown are the 3 main segments of most cemetery burial markers and a ground level marker. The concrete base is the longest and widest of the segments and is partially buried in the soil. It is the foundation for the monument and its base. The smooth polished surface of the monument and its base provide excellent bonding conditions for adhesives used in this invention.

FIG. 2 An over-all view is shown of the main memorial and a vase attached to the front face of the monument. The outward surface of the bolt head is lined with extra strength adhesives. The opposite end has male threads mateable with the memorial female threads. All the memorials have incorporated apertures lined with female threads. The apertures are surrounded by concavities that provide a retrofitting for the large cross-sectional area of the bolt head. The outward surface of the bolt head in all cases has an adhesive protected by a peel-off cover.

FIG. 3 The extra 5 to 7 inches of space on the end of the monument base is used to attach the shown memorials. To better illustrate the features of the drawings, the monument has been reduced in length. The features of the bolt head and memorials shown in FIG. 2 are also shown in this drawing. It should also be noted that the drawings in all illustrations are not to proportion.

FIG. 4 A plant pot with engaged threads is shown attached to the extended end-space of the monument base. Again, the monument was cut away to better illustrate the way the memorial is attached. As stated before, the drawings are not sized proportionately. The concavity surrounding the threaded aperture serves its purpose best with this memorial. However, it could serve in the same way if other types of fasteners were used that included the easy-on-easy-off features.

FIG. 5 An enlarged receiving base with a set of 3 bolts and platforms that help stabilize the attached multiple memorials make this displaying process different from the previous ones. It will be most effectively used in the front of the monument and attached to the extra space on the monument base. Ground level monuments shown along with the standard monuments in FIG. 1 can also be used in this kind of displaying process. The triple memorial offers an opportunity to do some individual designing and like the other memorials will take the place of previous more expensive ground level memorials the invention is designed to replace.

### A DETAILED DESCRIPTION OF THE INVENTION

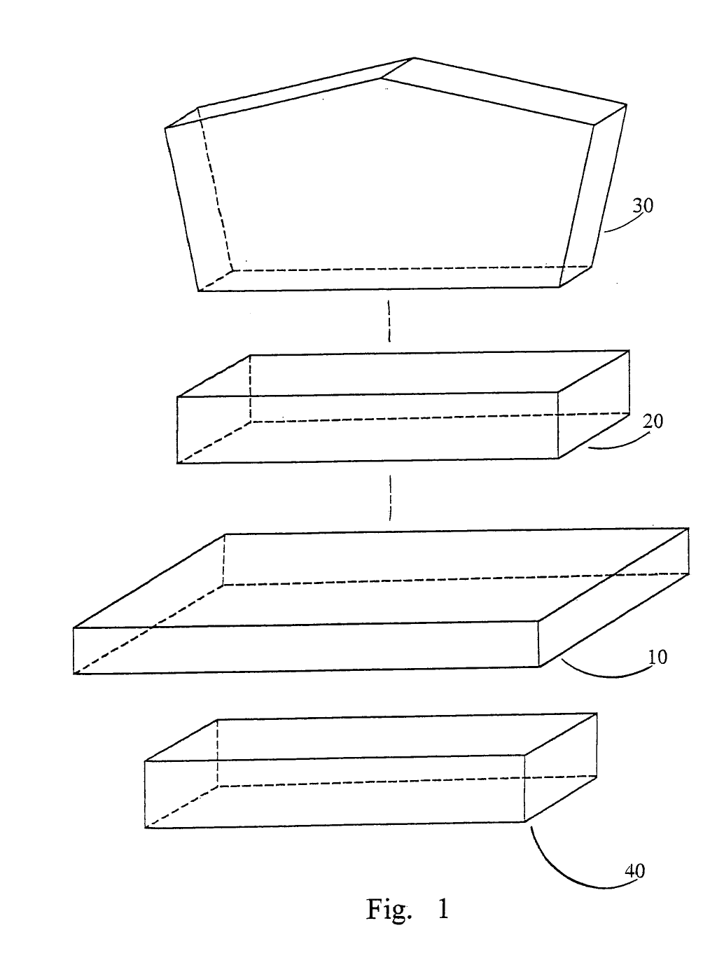

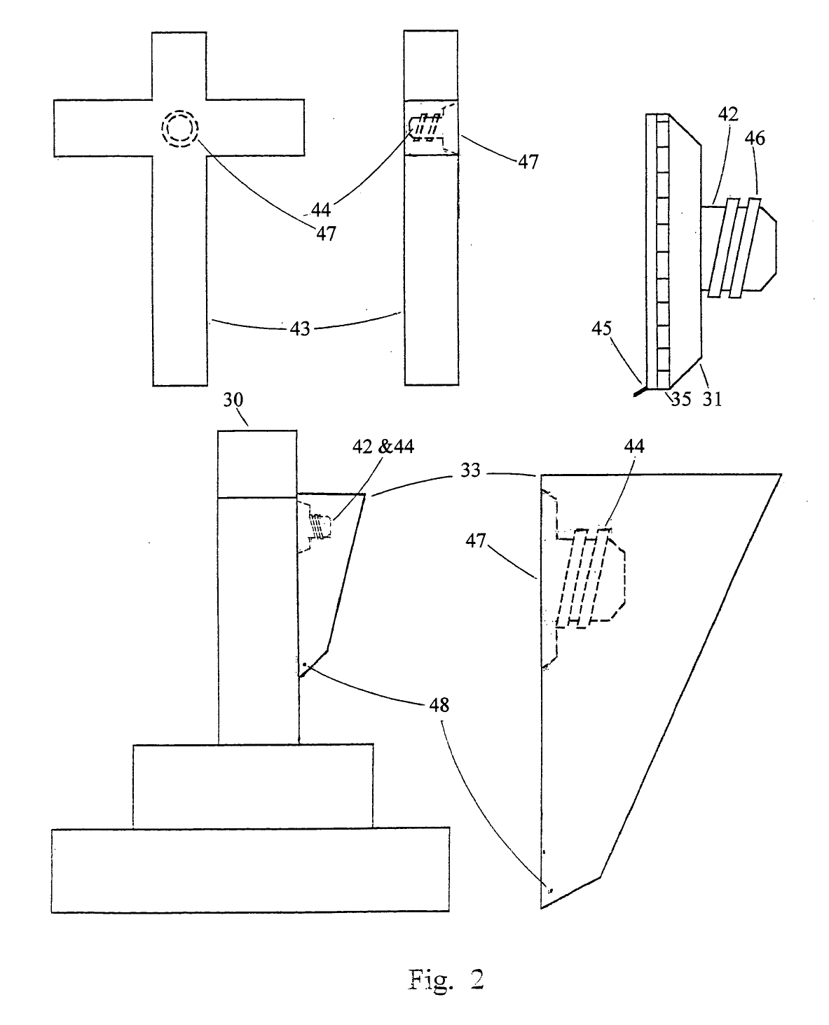

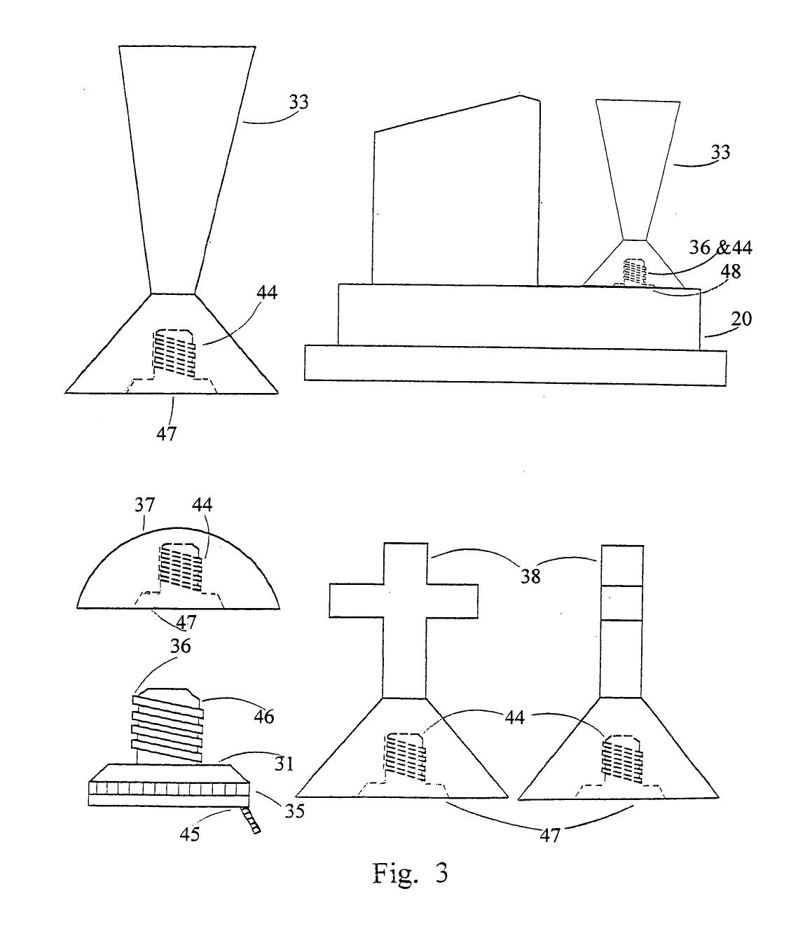

Segments of the most used cemetery burial markers are shown in FIG. 1. The concrete base 10 acts as the foundation for the monument 30 and its base 20. It is partially submerged in the soil and has the largest dimensions of the 3 segments. The extra length and width makes vegetation more accessible for trimming. The monument base 20 is bonded with an adhesive to the top of the concrete base 10. It is 6 to 8 inches wider and 10 to 14 inches longer than the bottom of the monument 30. These extra dimensions provide the area for attaching the bottom mount memorials shown in FIGS. 3, 4, and 5 which makes the invention a workable one. The ground level monument 40 is growing in popularity. Its top is positioned at ground level and offers no problem during ground maintenance. It too has a smooth surface and can be used with all the bottom mount memorials. The monument 30 is the focal point of the grave. It identifies the burial and is bonded to the top of the monument base 20. It and the monument base 20 features smooth polished surfaces which provide excellent bonding conditions when extra strength adhesives are used in this invention. Once the invention is attached, the memorials in FIGS. 2-4, will stay in place for long periods of time.

The vase 33 and cross 43 illustrated in FIG. 2 are used for side mounting on the front, rear and sometimes the end of the monument 30. The bolt 42 with counter clockwise male threads 46 is shorter than the one 36 & 46 shown in FIGS. 3 & 4. The shortened version provides a neater appearance when narrow memorials like the cross 43 are attached to the bolt 31. The flat surface of the bolt head 31 has an attached adhesive 35 and a protective peel-off cover 45. The 47 surrounding the female threaded apertre 44 retrofits the bolt head 31. The retrofit hides the entire bolt thereby creating a blending effect between the memorials and the substrata. The counter clockwise threads and the retrofit provides an opportunity to deter tampering and theft of the memorials. Counter clockwise threads are shown in all drawings, but this does not preclude the use of clockwise threads.

FIG. 3 shows the features of bottom mount memorials 33 & 38 and an off-season covering 37 for the bolt 46 and its head 31. The bottom mount memorials 33 & 38 with their mateable female threads 44 engage with the bolt male threads 46 and can be attached to the surfaces of the monument base 20 and ground level monument 40 shown in FIG. 1. The large cross-sectional area of the bolt head 31 with its longer male threaded bolt 36 and adhesive 35 protected by a peel-off cover 45 are used in the attachment process. However, a shorter bolt 42 like the one shown in FIG. 2 will suffice. The vase 33 has a water drain hole 48 at its bottom. The female threaded aperture 44 surrounded by a concavity 47 are shown incorporated in memorials 33, 38 and 47. To more effectively show the attachment of the vase 33 to the monument base 20 part of the monument 30 has been cut away in the drawing.

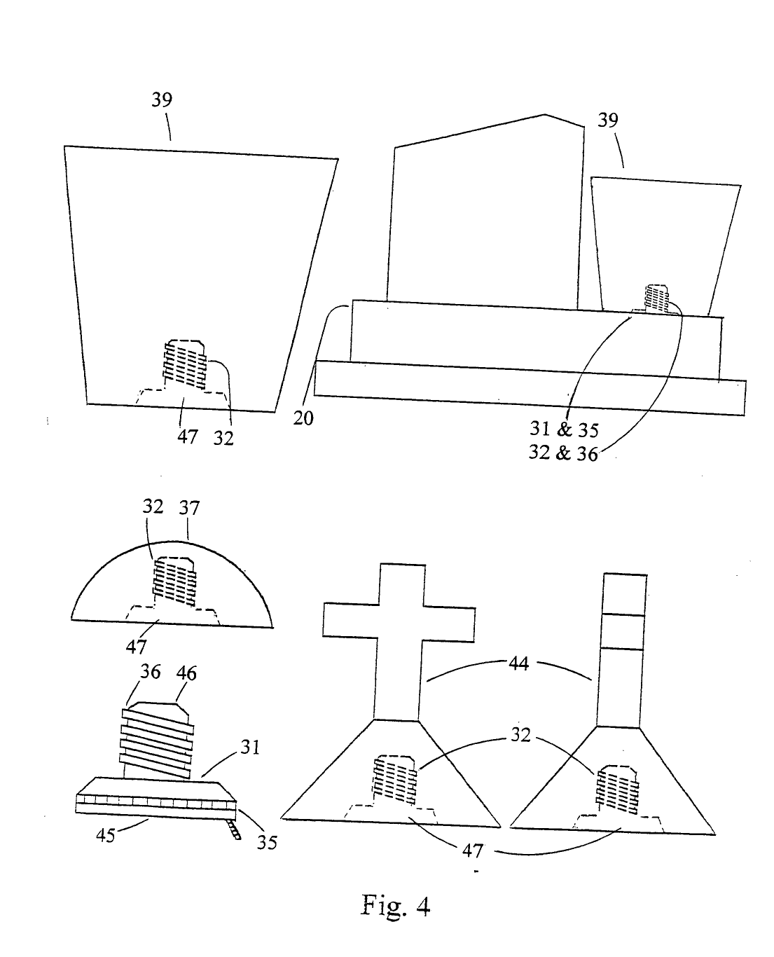

A plant pot 39 in FIG. 4 is attached to a bolt 46 by engaging the male threads 36 with the female threads 32 located in the incorporated aperture 35 of the pot 39. The concavity 47 is an important feature in this memorial. It allows the bolt head 31 to mesh with the pot 39 bottom concavity 47. The pot 39 with its extra weight rests mainly on the monument base instead of the bolt 46. The invention's quick-change feature allows exchanging the pot 39 for another memorial when living plants lose their appeal. The cross 44 or the off-season cover 37 can be used for replacements in this situation. The monument 30 in this illustration has also been cut away to more effectively show the memorial's attachment.

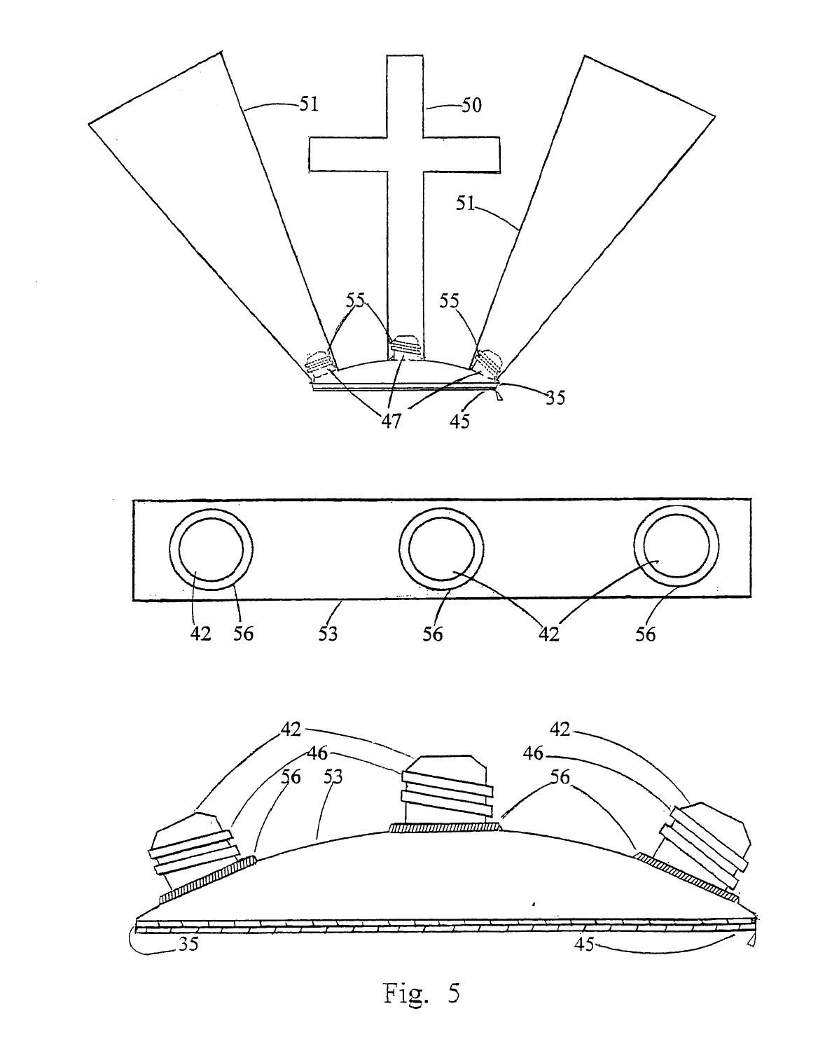

The features of the invention shown in FIGS. 1, 2, 3, & 4 are also shown in FIG. 5. However, this memorial base 53 is designed for a combination of memorials. The cross 50 is surrounded by two vases 51. The triple memorial will be attached in front of the monument 30, but will be bonded to the extra space on the monument base 20. The memorial base 53 is larger than those shown in the previous illustrations. The bolts 42 show only two counter-clockwise threads 46 surrounded by a circular platform 56. The memorial's concavity 47 will enclose the platform 56 and help stabilize the mounted memorials 50 & 51. The arch-like shape of the receiving base 53 provides the extra space needed for engaging the multiple memorials. After the memorials are engaged through the use of the mateable threads, 46 and 55, complete the attachment to the monument base by removing the protective cover 45 from the adhesive 35 and firmly press the base 53 onto the pre-selected space on the monument base 20. The drawings are not in proportion to better show the details.

The preceding drawings of the invention include several preferred examples, but it should be understood that the invention is not limited to those shown. Any modification of the invention can be included as long as it does not depart from the invention's stated scope and purpose. The products can be made of various materials, but the inexpensive molded plastics would be in keeping with the intent of the invention to make it competitive with the memorials it is intended to replace.

I claim:

1. A device with means to removably attach cemetery memorials to horizontal and vertical smooth surfaces of graveside markers, comprising:
a) a flat only, molded plastic bolt-head thereon outward flat, only side having an attached two-sided protected pressure sensitive tape adhesive herewith said protection removed conveniently lends attachment to said smooth surfaces, and thereon inward convex side an incorporated centrally located male screw threaded bolt and,
b) a companion unit with a bottom or side concavity matching convex shape of said bolt centrally located herein a centered aperture lined with mateable female screw threads herewith means for a completely enveloped engagement to said bolt and base thereby process forms off-ground-memorial display.
